(19) United States
(12) Patent Application Publication
(10) Pub. No.: US 2009/0260256 A1
(43) Pub. Date: Oct. 22, 2009

(54) Apparatus for controlling a clothes dryer

(75) Inventor: Sebastien Beaulac, Queretaro (MX)

Correspondence Address: STEVEN W. SMITH, 4224 Hartlees Field Road, Denton, TX, 76208, US

(73) Assignee: MABE CANADA INC., Burlington (CA)

(21) Appl. No.: 12/315,517

(22) Filed: Dec. 4, 2008

(30) Foreign Application Priority Data
Apr. 18, 2008 (CA) 2,629,495

(51) Int. Cl. F26B 13/10; F26B 21/06; F26B 19/00; F26B 11/02

(52) U.S. Cl. 34/528; 34/543; 34/553; 34/108

(57) ABSTRACT

A clothes dryer providing clothes care has a main controller operable with an outlet temperature sensor for receiving the outlet temperature values. The controller is operable with a heater to controllably raise the outlet temperature of air flowing out of a dryer drum above an outlet clothes care target temperature value whereupon the controller operates the heater to raise the outlet temperature to an overshoot temperature value. The clothes care temperature value is determined by a heat setting selected by a user. The overshoot temperature value is sufficiently high to reduce drying time but sufficiently low as to prevent damage to damp clothing. Once the outlet temperature rises to the clothes care temperature, the controller reduces power to the heater, bringing the outlet temperature back down to the clothes care temperature. The controller de-energizing the heater for a cooldown cycle upon detection of a dry load.

### FIELD OF THE INVENTION

The present invention relates to an appliance for drying clothing articles, and more particularly, to a dryer using microprocessor based power controls for controlling dryer operation.

### BACKGROUND OF THE INVENTION

Household clothes dryers are used to dry clothing of different load sizes and fabric types. An important factor in proper dryer operation is the control of temperature within the drum. Another factor is that household dryers vary in their exhaust duct length. Longer exhaust ducts provide a greater resistance to airflow through the drum and thus provide greater temperature accumulation within the drum than do shorter exhaust ducts.

Moisture content in the clothes tumbling within the dryer is typically detected using voltage-based moisture sensors located within the drum. As the clothes come into contact with the moisture sensors, a circuit is formed and voltage drop occurs at the sensors. The magnitude of the voltage drop is used to determine the moisture content of the clothes.

Dryers often rely on thermostats in order to control drum temperature by cycling the heater on and off. However, thermostat control does not provide for efficient temperature control and response times can be improved by the use of a thermistor-relay combination. The electrical relay can be cycled only once about every minute without compromising its reliability. This time interval still produces large temperature variations between cycles. In order to better control temperature variation, the electrical relay can be replaced by a triac, which permits power cycling at a frequency of 60 Hz. Similarly, the use of a two-stage gas valve in gas dryers can improve the temperature variation over single-stage gas valve.

It is common practice to control drum temperature taking into consideration load size, moisture content and fabric type. Household clothes dryers are typically operated below a predetermined maximum drum temperature as exceeding this temperature may result in damage to clothing and may also cause a fire in the drum. However, an element not usually considered in determining the maximum drum temperature is the moisture content of the clothes which can protect the clothes from higher temperatures.

### SUMMARY OF THE INVENTION

To overcome the disadvantages and limitations of existing clothes dryers, the present invention provides an appliance for drying clothing articles having efficient power control, which controls the power to the heating unit to optimize drying time.

The present invention uses a main controller that controls a rise in temperature at the drum outlet to exceed an outlet clothes care target temperature value at an initial stage of the drying cycle.

In one embodiment of the present invention there is provided an appliance for drying clothing articles comprising a drum for receiving the clothing articles having an air flow inlet and an air flow outlet, a motor for rotating the drum about an axis and a heater for heating air supplied to the drum via the air flow inlet during a drying cycle. There is further provided an outlet temperature sensor for sensing temperature of air flowing out of the drum via the air flow outlet and generating outlet temperature values related thereto. There is further provided a heat setting selector operable by a user to select an outlet clothes care target temperature value relating to delicateness of clothing to be dried, whereby clothing is not damaged when heated to the selected clothes care target temperature value. The appliance further comprises a main controller operable with the outlet temperature sensor for receiving the outlet temperature values. The main controller is further operable to control power to the heater, at an initial stage of a drying cycle, to raise the outlet temperature above the outlet clothes care target temperature value to an overshoot temperature value. Once the outlet temperature rises to the outlet clothes care target temperature value, the main controller reduces power to the heater gently stabilizing the outlet temperature back down to the outlet clothes care target temperature value.

By having the temperature of air flowing out of the drum rise above the outlet clothes care target temperature value, the main controller takes advantage of the moisture present in, or wetness of, the clothing, which is greater at the beginning of the drying cycle, to prevent the clothing from being damaged and thereby allows the temperature in the drum to be elevated to a higher temperature than previously utilized to decrease the drying time of the drying cycle. By reducing power to the heater once the sensed outlet temperature value reaches the outlet clothes care target temperature value, the thermal inertia of the clothes dryer raises the outlet temperature above the outlet clothes care target temperature value providing an overshoot in temperature. This overshoot is desired as it results in a decrease in drying time that would not occur if the overshoot was not present.

The heat setting selector permits the user to select the setting of heat to be applied during the drying cycle. For example, the operator may choose a high heat setting to apply a high degree of heat during the drying cycle, or alternatively may choose a lower heat setting for more delicate clothing. It should be understood that other heat settings may be available to the operator. A higher heat setting results in a higher clothes care target temperature value and a lower heat setting will result in a lower clothes care target temperature value being utilized by the main controller during a drying cycle.

In an alternative embodiment of the present invention, the main controller operates the heater to continually raise the outlet temperature until the outlet temperature reaches the outlet clothes care target temperature value. Thereafter, the main controller operates the heater at reduced power to gently stabilize the outlet temperature back down to the outlet clothes care target temperature value, thus completing the initial stage of the drying cycle. This has the advantage of preventing damage to the load as it loses moisture due to the overshoot temperature value.

In another alternative embodiment of the present invention, after the outlet temperature has reached an overshoot temperature value, the main controller does not increase the power applied to the heater to control the outlet temperature unless the outlet temperature value reaches a low threshold temperature value below the outlet clothes care target temperature value to maintain a lower temperature value in the drum to complete the drying of the clothing.

In another alternative embodiment, the appliance further comprises an inlet temperature sensor for sensing inlet drum temperature. The controller may use the inlet temperature sensor values to reduce inlet temperature to an inlet clothes care temperature value. This has application in more restricted exhaust installations or lower temperature selections by the user.

In another alternative embodiment of the present invention, the inlet and outlet temperature sensors are used conjointly to control the heater power.

In another alternative embodiment, the appliance further comprises a processor operably connected with the main controller. The processor may further comprise a counter for counting in predetermined intervals from a starting value to a predetermined period value whereupon power supplied to the heater is refreshed and the counter is reset to the starting value.

In another alternative embodiment, the appliance may further comprise a moisture sensor located within the drum for sensing moisture content of the load and generating a moisture content value related thereto. The main controller is operable with the moisture sensor. The main controller de-energizes the heater once the moisture sensor detects a dry load.

### BRIEF DESCRIPTION OF THE DRAWINGS

For a better understanding of the nature and objects of the present invention reference may be had by way of example to the accompanying diagrammatic drawings.

FIG. 1 is a perspective view of an exemplary clothes dryer that may benefit from the present invention;

FIG. 2 is a block diagram of a controller system used in the present invention;

FIG. 3 is a flow chart showing the operation of the clothes dryer appliance of the present invention;

FIG. 4 is a flow chart showing another operation of the present invention;

FIG. 5 is a plot of inlet temperature rise vs. time for a large size load in a gas dryer; and

FIG. 6 is a plot of outlet temperature rise vs. time for a small size load.

### DETAILED DESCRIPTION

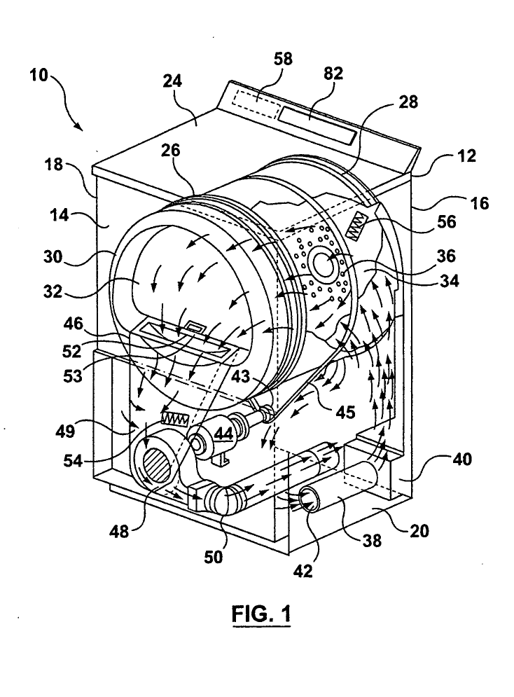

FIG. 1 shows a perspective view of an exemplary clothes dryer 10 that may benefit from the present invention. The clothes dryer 10 includes a cabinet or a main housing 12 having a front panel 14, a rear panel 16, a pair of side panels 18 and 20 spaced apart from each other by the front and rear panels 14,16, and a top cover 24. Within the housing 12 is a drum or container 26 mounted for rotation around a substantially horizontal axis. A motor 44 rotates the drum 26 about the horizontal axis through, for example, a pulley 43 and a belt 45. The drum 26 is generally cylindrical in shape, has an imperforate outer cylindrical wall 28, and is closed at its front by a wall 30 defining an opening 32 into the drum 26. Clothing articles and other fabrics are loaded into the drum 26 through the opening 32. It should be understood that the opening 30 is normally closed by a door (not shown) in the front panel 14. A plurality of tumbling ribs (not shown) are provided within the drum 26 to lift the articles and then allow them to tumble back to the bottom of the drum 26 as the drum rotates. The drum 26 includes a rear wall 34 rotatably supported within the main housing 12 by a suitable fixed bearing. The rear wall 34 includes a plurality of holes 36 that receive hot air that has been heated by a heater such as a combustion chamber 38 and a rear duct 40. The combustion chamber or heater 38 receives ambient air via an inlet 42 and heats the air using power from an external source (not shown in figures). Although the exemplary clothes dryer 10 shown in FIG. 1 is a gas dryer, it could just as well be an electric dryer having electric resistance heater elements located in a heating chamber positioned adjacent the imperforate outer cylindrical wall 28 which would replace the combustion chamber 38 and the rear duct 40. The heated air is drawn from the drum 26 by a blower fan 48 which is also driven by the motor 44. It should be understood that in alternative embodiments, separate motors may be used to operate both the drum 26 and blower fan 48. The air passes through a screen filter 46 at outlet 52, which traps any lint particles. As the air passes through the screen filter 46, it enters a trap duct seal 49 and is passed out of the clothes dryer 10 through an exhaust duct 50. After the clothing articles have been dried, they are removed from the drum 26 via the opening 32.

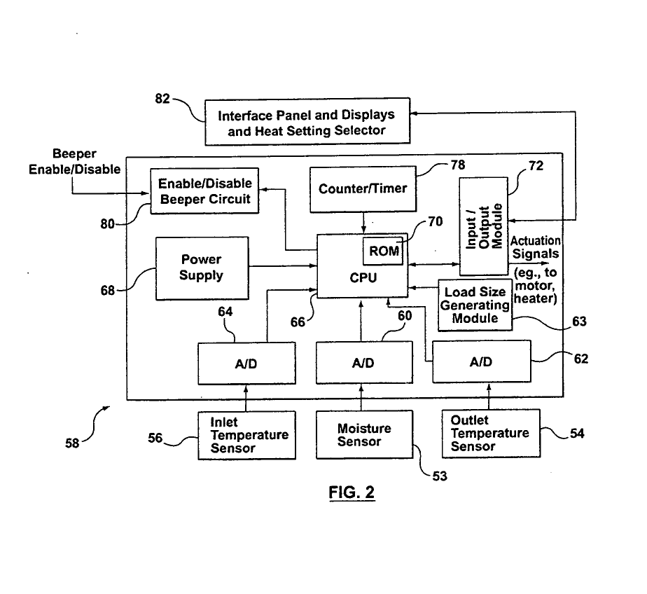

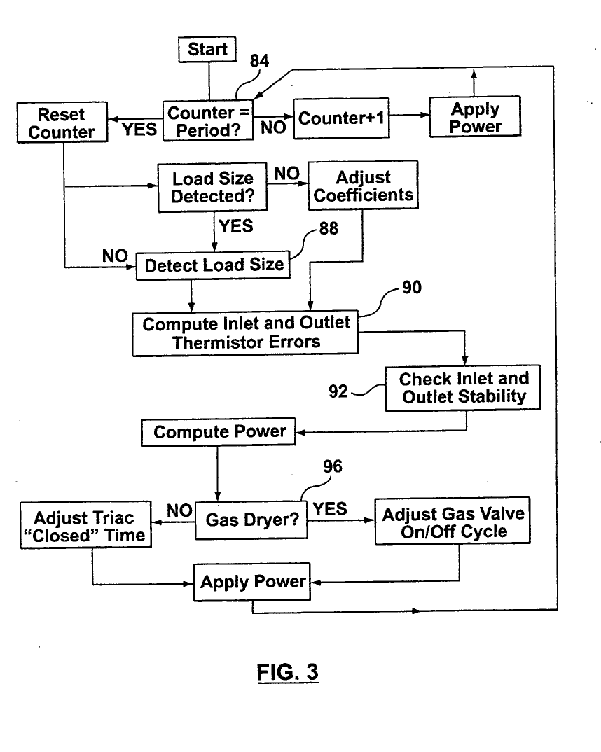

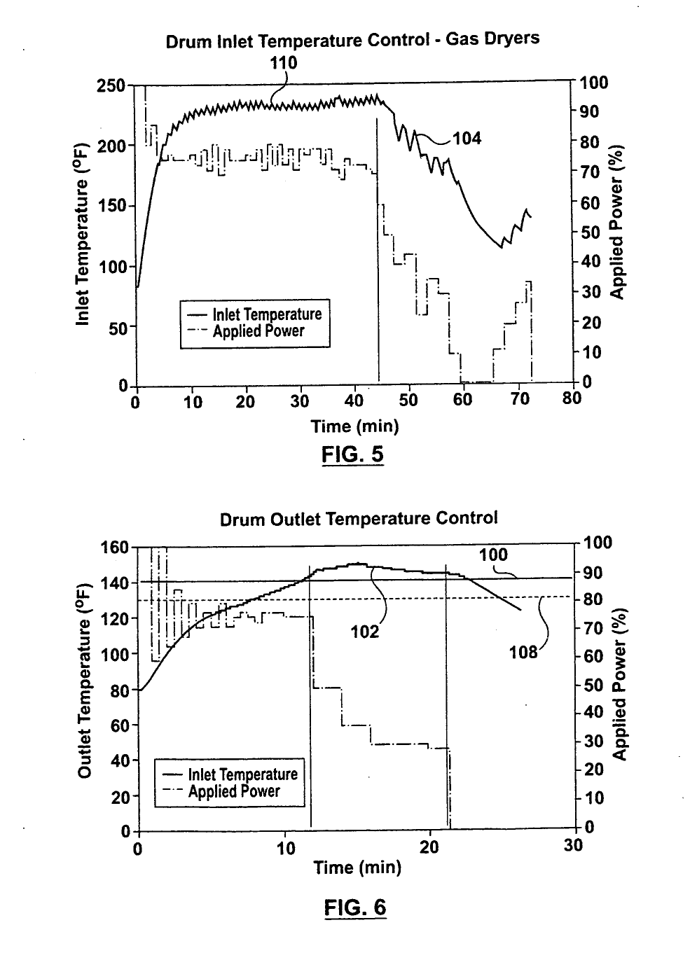

Referring to FIGS. 1 and 2, one embodiment of the present invention provides for an inlet temperature sensor 56 that is used to sense temperature signals from the heated air flowing into the drum 26 via the inlet 42. The inlet temperature sensor 56 is mounted in the air flow path entering into the drum 26. After sensing the temperature of the heated air passing into the drum 26, the inlet temperature sensor 56 generates and outputs an inlet temperature value related thereto. This inlet temperature value is received by the main controller or controller 58. An outlet temperature sensor 54 is mounted within the air flow outlet 52 in the air flow path exiting the drum 26. The outlet sensor 54 may be located in the trap duct 49 or alternatively in the exhaust duct 50. The outlet temperature sensor 54 generates and outputs an outlet temperature value related thereto. This outlet temperature value is received by the main controller 58. The inlet and outlet temperature values are used by the main controller 58, in the operational diagram of FIG. 3, to regulate the drying cycle. It should be noted that in one embodiment, the inlet and outlet temperature sensors 56, 54 may comprise thermistors. A plurality of inlet and outlet temperature values are received over time by the main controller sampling sensors 54, 56 at predetermined time intervals via respective A/D converters 62, 64. In one embodiment of the present invention applicable to more restricted exhaust installations or lower temperature selections, the inlet temperature sensor values may be used to reduce the temperature at the inlet to an inlet clothes care temperature value. The inlet clothes care temperature is dependent upon the heat setting selected by the user. In the preferred embodiment, a high heat setting sets the inlet clothes care target temperature value to approximately 215° F. and a low heat setting sets the inlet clothes care target temperature value to approximately 150° F. It should be understood that in some embodiments, and as shown in FIGS. 5 and 6 together, both the inlet and outlet temperature values may be used to conjointly control the level of power applied at the heater 38 by the controller 58.

A detailed illustration of the main controller 58 is shown in FIG. 2. A moisture sensor 53 is used to communicate to the main controller 58 the level of moisture content in the load in the drum 26 via analog to digital converter 60. Moisture sensor 53 typically comprises a pair of spaced-apart electrodes and further comprises circuitry for generating and outputting a voltage sensor value to the main controller 58 based on the electrical or ohmic resistance of the load. The moisture sensor 53 is located on the front interior wall of the drum and alternatively may be mounted on the rear drum wall 34. Clothes tumbling in the dryer drum 26 will come into contact with the moisture sensor 53. The moisture sensor 53 may provide a continuous representation of the moisture content of the load in a range suitable for processing by main controller 58. It will be appreciated that the signal indicative of the moisture content need not be a voltage signal being that, through the use of a voltage-controlled oscillator, a moisture signal could be chosen as having a frequency that varies proportionally to the moisture content of the articles instead of a signal whose voltage varies proportionally to the moisture content of the articles. When wet clothes contact the moisture sensor 53, the resistance across the voltage sensor is low. When dry clothes contact the moisture sensor 53 electrodes, the resistance across the voltage sensor is high. When the resistance across the voltage sensor is sufficiently high, a dry load may be indicated. There may be situations that result in erroneous indications of the actual level of dryness of the articles. For example, in a situation when wet clothes are not contacting the moisture sensor electrodes, such as with a small load, the resistance across the sensor is very high (open circuit), which may falsely indicate a dry load. Further, if a conductive portion of dry clothes, such as a metallic button or zipper, contacts the sensor electrodes, the resistance across the sensor would be low, which may falsely indicate a wet load. Hence, when the clothes are wet there may be times when the moisture sensor 53 will erroneously sense a dry condition (high resistance) and, when the clothes are dry, there may be times when the moisture sensor 53 will erroneously sense a wet condition (low resistance).

As previously mentioned, the inlet temperature sensor 56 generates an inlet temperature value that is received by the controller 58 via an analog to digital (A/D) converter 64. Similarly, the controller 58 also receives values generated by the outlet temperature sensor 52 via an A/D converter 62. The temperature value representation from A/D converters 64 and 62 and counter 78 are also sent to a processor (CPU) 66 for further processing which is described below in more detail. It should be understood that in one embodiment, the processor may comprise a proportional-integral-derivative (PID) controller. The CPU 66 also receives outlet temperature value signals from the outlet temperature sensor 54 via A/D converter 62. The CPU 66, which receives power from the power supply 68, comprises one or more processing modules stored in a suitable memory device, such as a read only memory (ROM) 70. It will be appreciated that the memory device need not be limited to ROM being that any memory device, such as an erasable programmable read only memory (EPROM) that stores instructions and data will work just as effectively. Once it has been determined, via the moisture sensor 53, that the clothing articles have reached a desired degree of dryness, then CPU 66 sends respective signals to an input/output module 72, which in turn sends respective signals to de-energize the heater 38. When the heater 38 is de-energized, a cooldown cycle occurs wherein the clothes are tumbled in the drum for a period until excessive heat has been removed from the load. Alternatively, the CPU 66 may de-energize the motor 44 as well as the heater 38, thus ending dryer operation. As the drying cycle is shut off, the controller 58 may activate a beeper (not in figures) via an enable/disable beeper circuit 80 to indicate the end of the drying cycle to a user. An electronic interface and display panel 82 allows for a user to program operation of the dryer 10 and further allows for monitoring progress of respective cycles of operation of the dryer 10. The interface and display panel 82 further comprises a heat setting selector that allows the user to select a temperature setting based on the delicateness of the clothes to be dried. Such temperature settings are known as normal, permanent press and delicate, for example. The selection of the temperature, or heat setting, effectively sets the temperature value of what is referred to herein as the outlet clothes care target temperature value. The CPU 66 of the main controller 58 also controls the energizing of the heater 38 via input/output module 72 to effect temperature changes and control in the clothes dryer 10 in accordance with the present invention in which temperature control is now described.

FIG. 2 shows the main controller 58 and FIG. 3 shows the operation of the clothes dryer according to the present invention. The main controller 58 regulates the drying cycle of the dryer 10. As previously mentioned, main controller 58 is operable with a counter or a timer 78 which is configured to count upwards or downwards by predetermined intervals beginning at a starting value until it reaches a predetermined period value as shown in step 84. When the period value is reached, the processor 66 will refresh the level of power applied to the heater 38 and thereby the heat applied at inlet 42 and the counter 78 will be reset. If the period value is not reached after the interval is counted, then the counter is updated and increased or decreased accordingly by one interval value, depending on upwards or downwards counting, and the power at the inlet is applied for another cycle and step 84 repeats.

In one embodiment of the present invention, a load size parameter generating module 63 is operable with the outlet temperature sensor 54 to sense temperature of air exiting the drum 26 via outlet 52. The load size parameter generating module 63 outputs to the processor 66 input parameters corresponding to the load size. The load size input parameters are used to adapt the length of the dry cycle. In one embodiment of the present invention, it is shown in FIG. 3 that after the counter 78 has reached the period value in step 84, the load coefficients will be determined by the main controller 58 as shown in step 88. The load coefficients may vary depending on load size. Larger loads produce larger coefficients and smaller loads produce smaller coefficients. A larger load of clothing can absorb more heat and provide more thermal buffer between the inlet 54 and the outlet 52. Therefore, the rate at which the outlet temperature is raised in the drum may be lower with a larger load than the rate at which the outlet temperature for a smaller load may be raised.

At step 90, the controller 58 will calculate inlet and outlet temperature sensor error values in order to determine whether the inlet and outlet temperature sensor values are close to the temperature desired at different times in the cycle. The temperature sensor error values represent the difference between the actual temperature value sensed by the inlet or outlet sensor 56, 54 and the temperature that is desired. For example, if the temperature value at the inlet temperature sensor 56 is higher than stabilized temperature value 110 (shown in FIG. 5) before the outlet temperature value has reached the clothes care temperature value 100, the controller 58 will decrease power supplied to the heater 38 for one cycle of the counter 78 until the counter 78 refreshes power supplied to the heater 38 after the subsequent cycle. At step 92, inlet and outlet stability is checked. A state of stability is reached when the inlet or outlet sensor 56,54 value attains the appropriate temperature value and maintains that value for the appropriate time period, where required. The level of power applied to the heater 38 is computed at step 94 and is discussed hereinafter.

At step 96, it is determined whether the dryer is a gas dryer or an electric dryer. If the dryer 10 comprises an electric dryer, heat is controlled via the adjustment of a triac (not shown in figures) “closed” time, in one embodiment of the present invention. The triac may be configured to permit cycling at, in one embodiment, 60 Hz. If the dryer 10 comprises a gas dryer, heat is controlled by turning on and off gas valve stages (not shown in figures) based on valves and relay reliability. In one embodiment of the present invention, the gas valves may be controlled by fixing cycle time and applying a given power average over a predetermined time, for example, one minute. The use of a two-stage gas valve may improve the temperature variation over a single-stage gas valve.

As shown in step 94 of FIG. 3, inlet and outlet temperature is regulated by controller 58. In the preferred embodiment, the controller 58 may operate the heater 38 at approximately 80% power in order to maintain outlet temperature above low temperature value 108, after the overshoot. In the preferred embodiment, the inlet temperature generally declines after the outlet temperature reaches the outlet clothes care target temperature value, but may have sudden increases in temperature at the inlet 42 or brief periods of stable temperature (not shown in figures) during the general decline. These periods of stable temperature and sudden increases represent error corrections 104. It may occur that the temperature at the outlet 52 decreases either too suddenly or not quickly enough during this phase to maintain an efficient temperature in the drum 26, so the inlet temperature is corrected whereafter it continues to generally decline.

It can be seen in FIGS. 5 and 6 that the outlet temperature gradually rises to reach the outlet clothes care target temperature value 100, but then temporarily exceeds, at an overshoot 102, said clothes care target temperature value 100 prior to a gradual decrease. Power is applied to the heater to increase the outlet temperature above the outlet clothes care target temperature value 100 into overshoot 102. Once the outlet temperature reaches clothes care target temperature value 100, the level of power applied to the heater will generally decline. Accordingly, inlet temperature will also generally decline. It should be understood that the thermal inertia of the clothes dryer carries the outlet temperature into the overshoot 102. The main controller 58 will not allow for an increase in heater power level after the outlet temperature value has reached the overshoot value unless the outlet temperature value decreases below the low threshold temperature value 108, in which case the level of power may be increased to raise the temperature to a value above the low threshold temperature value 108 until the moisture sensor 53 signals a dry load. Clothes with a high moisture content can safely absorb more heat than clothes lacking moisture. Therefore, moist clothes are not damaged in the overshoot 102 of the outlet clothes care target temperature value 100. The duration of the overshoot 102 can be influenced by load size. Larger loads will hold more moisture, and therefore, the rise and fall of the overshoot 102 can extend over a longer time period without risking damage to the clothing. Smaller loads hold less moisture and therefore the temperature must return below the clothes care temperature value 100 sooner, therefore the duration of the overshoot 102 must be shorter to prevent clothing damage. In the preferred embodiment, the overshoot comprises a 10% to 15% rise in temperature above the outlet clothes care target temperature value 100. This translates to approximately 5° F. to 15° F. above the outlet clothes care target temperature value 100.

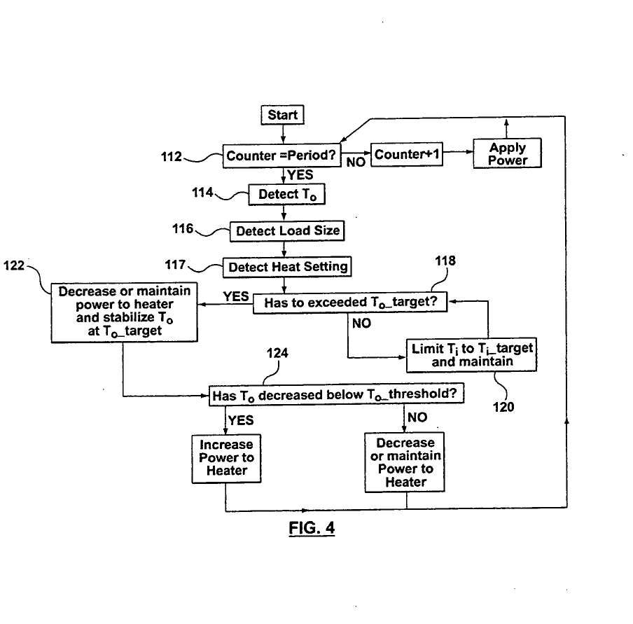

Referring to FIG. 4, there is shown one embodiment of the power control system of the clothes dryer 10. At step 112, the counter 78 is checked to determine whether the period value has been attained. If the period value has not been attained, the counter 78 is updated by one interval value, and re-applies power to the heater 38. If the counter 78 has attained the period value, the counter 78 is reset and outlet temperature value (Tₒ), load size and heat setting are checked as in steps 114, 116 and 117, the applied level of power applied at the heater 38 is refreshed and the counter resets to its starting value. The heat setting of step 117 may be selected based on the type of fabric in the load. For example, a lower heat setting may be selected to dry a load of delicate clothing whereas a higher heat setting may be chosen to dry a regular load. In the preferred embodiment, a high heat setting sets the outlet clothes care target temperature value 100 to approximately 145° F. and a low heat setting sets the outlet clothes care target temperature value 100 to approximately 105° F. Of course, other temperature settings between these values can be available to a user depending on the nature or delicateness of the clothes to be dried. At step 118, if the outlet temperature value has not yet exceeded the outlet clothes care target temperature value 100 (Tₒ_{_{—}}_{target}) (FIG. 6), then, as in step 120, the inlet temperature value (Tᵢ) is increased and then maintained until the outlet temperature value has reached the clothes care temperature value 100. At step 122, power is gradually decreased or maintained in order to gradually reduce outlet temperature at least to the outlet clothes care target temperature value 100. At step 124, it is determined whether outlet temperature has decreased below the low threshold temperature (Tₒ_{_{—}}_{threshold}) 108. If yes, power is increased to the heater 38 and the counter 78 is once again checked as in step 112. If not, power is decreased at the heater 38 in order to lower the outlet temperature and the counter 78 is checked as in step 112.

While the invention has been described in terms of various specific embodiments, those skilled in the art will recognize that the invention can be practiced with modifications within the scope of the present invention as disclosed herein.

What is claimed is:

1. An appliance for drying clothing articles, the appliance comprising:
a drum for receiving the clothing articles, the drum having an air flow inlet and an air flow outlet;
a motor for rotating the drum about an axis;
a heater for heating air supplied to the drum via the air flow inlet during a drying cycle;
an outlet temperature sensor for sensing temperature of air flowing out of the drum via the air flow outlet and generating outlet temperature values related thereto;
a heat setting selector operable by a user to select an outlet clothes care target temperature value relating to delicateness of clothing to be dried whereby clothing is not damaged when heated to the selected clothes care target temperature value; and,
a main controller operable with the outlet temperature sensor for receiving the outlet temperature values, the main controller being operable to control power to the heater at an initial stage of a drying cycle to raise the outlet temperature above the outlet clothes care target temperature value to an overshoot temperature value, and once the outlet temperature rises to the outlet clothes care target temperature value the main controller reducing power to the heater to gently stabilize the outlet temperature back down to the outlet clothes care target temperature value.

2. The appliance of claim 1 wherein the main controller operates the heater to continually raise the outlet temperature until the outlet temperature reaches the outlet clothes care target temperature value and thereafter the main controller operates the heater at reduced power to reduce the outlet temperature back down to the outlet clothes care target temperature value completing the initial stage of the drying cycle.

3. The appliance of claim 2 wherein:
the outlet temperature sensor comprises a thermistor.

4. The appliance of claim 2 wherein:
the main controller comprises a proportional-integral-derivative (PID) controller.

5. The appliance of claim 2 further comprising a processor operably connected with the main controller wherein:
said processor further comprising a counter for counting in predetermined intervals from a starting value to a predetermined period value whereupon power supplied to the heater is refreshed and the counter is reset to the starting value.

6. The appliance of claim 5 further comprising a moisture sensor located within the drum for sensing moisture content of the load and generating a moisture content value related thereto; and
the main controller is operable with said moisture sensor to de-energize the heater once the moisture sensor detects a dry load.

7. The appliance of claim 2 wherein:
the overshoot comprises a temperature increase in the range of 10% to 15% above the outlet clothes care target temperature value.

8. The appliance of claim 2 wherein:
the appliance further comprises an inlet temperature sensor for sensing temperature of air flowing into the drum via the air flow inlet and generating an inlet temperature value related thereto;
the main controller operable with the inlet temperature sensor for receiving the inlet temperature values;
the main controller being operable to control power at the heater in response to the inlet temperature values to reduce inlet temperature to an inlet clothes care temperature value.

9. The appliance of claim 8 wherein:
the inlet and outlet temperature sensors are used conjointly to control power to the heater.

10. The appliance of claim 1 wherein after the initial stage of the drying cycle the main controller operates the heater to control the outlet temperature between the outlet clothes care target temperature value and a low threshold temperature value below the outlet clothes care target temperature value.

11. The appliance of claim 10 wherein:
the main controller does not increase the level of power applied at the heater once the outlet temperature has reached the overshoot temperature value unless the outlet temperature value decreases below the low threshold temperature value.

12. The appliance of claim 1 wherein:
the outlet temperature sensor comprises a thermistor.

13. The appliance of claim 1 wherein:
the main controller comprises a proportional-integral-derivative (PID) controller.

14. The appliance of claim 1 further comprising a processor operably connected with the main controller wherein:
said processor further comprising a counter for counting in predetermined intervals from a starting value to a predetermined period value whereupon the level of power applied to the heater is refreshed and the counter is reset to the starting value.

15. The appliance of claim 14 further comprising a moisture sensor located within the drum for sensing moisture content of the load and generating a moisture content value related thereto; and
the main controller is operable with said moisture sensor to de-energize the heater once the moisture sensor detects a dry load.

16. The appliance of claim 1 wherein:
the overshoot comprises a temperature increase in the range of 10% to 15% above the outlet clothes care target temperature value.

17. The appliance of claim 1 wherein:
the appliance further comprises an inlet temperature sensor for sensing temperature of air flowing into the drum via the air flow inlet and generating an inlet temperature value related thereto;
the main controller operable with the inlet temperature sensor for receiving the inlet temperature values;
the main controller being operable to control power at the heater in response to the inlet temperature values to reduce inlet temperature to an inlet clothes care temperature value.

18. The appliance of claim 17 wherein:
the inlet and outlet temperature sensors are used conjointly to control power to the heater.

19. An appliance for drying clothing articles, the appliance comprising:
means for holding the clothing articles;
means for heating air;
inlet means for supplying heated air to the holding means;
outlet means for removing outlet air from the holding means, the outlet means including outlet temperature sensing means for sensing a temperature of the outlet air and generating outlet temperature values;
temperature setting means for setting a target temperature value for the outlet air; and
controlling means, operably connected to the temperature setting means, the outlet temperature sensing means, and the heating means, for receiving the outlet temperature values and for controlling power to the heating means responsive to the outlet temperature values and the target temperature value for the outlet air, wherein the controlling means includes:
means for increasing power to the heating means to a level sufficient to raise the outlet air temperature above the target temperature value to an overshoot temperature value at an initial stage of a drying period; and
means for reducing power to the heating means to stabilize the outlet air temperature at the target temperature value upon receiving an indication from the outlet temperature sensing means that the outlet temperature has risen to the target temperature value.
